(19) United States
(12) Patent Application Publication
(10) Pub. No.: US 2006/0276298 A1
(43) Pub. Date: Dec. 7, 2006

(54) Bearing adjuster lock and method of use

(76) Inventors: Mark E. Rodgers, Augusta, MI (US); Gary A. Turner, Three Rivers, MI (US); James F. Ziech, Kalmazoo, MI (US)

Correspondence Address: MARSHALL & MELHORN, FOUR SEAGATE, EIGHT FLOOR, TOLEDO, OH, 43604, US

(21) Appl. No.: 11/454,333

(22) Filed: Jun. 16, 2006

Related U.S. Application Data
(63) Continuation-in-part of application No. 10/724,267, filed on Nov. 26, 2003, now abandoned.

(51) Int. Cl. F16H 48/06

(52) U.S. Cl. 475/231

(57) ABSTRACT

A method and apparatus for locking a bearing adjuster to a combined differential carrier and bearing cap is provided. In one embodiment of the invention, a locking device extends through the bearing cap to the bearing adjuster to deform threads on the bearing adjuster to lock the bearing adjuster to the combined differential carrier and bearing cap. In another embodiment of the invention, a locking device extends through the bearing adjuster to deform on the combined differential carrier and bearing cap threads on the differential case to lock the bearing adjuster to the combined differential carrier and bearing cap.

### RELATED APPLICATIONS

This application is a continuation-in-part of U.S. application Ser. No. 10/724,267 filed Nov. 26, 2003, herein incorporated by reference in its entirety.

### FIELD OF THE INVENTION

The present invention relates to a lock for a bearing adjuster for a differential bearing and an input bearing.

### BACKGROUND OF THE INVENTION

The current practice to adjust differential bearings is to provide a shim pack, selective spacer or threaded adjuster to set the bearing preload. Spacers and shims have the disadvantage that they are difficult to install, provide only a set increment of adjustment and are costly. Threaded adjusters are easy to assemble, but require some type of locking mechanism to ensure that the adjuster does not rotate in service. Typical lock mechanisms are cumbersome due to the necessity to align a keeper (lock plate, cotter pin or cap screw) in a slot. Alternately, a thin ductile member such as a stamped lock plate or nut flared extension can be staked into a keyway. This staking has the advantage that it is infinitely adjustable, but is highly dependent on the integrity of the stake operation. The stake depth is a variable that can affect the bearing adjuster retention in service.

Other bearing adjuster lock mechanisms attempt to pinch the adjuster threads axially to take all the clearance out of the threads. These pinch systems are infinitely adjustable, but they rely on friction which is highly variable, as opposed to a mechanical lock, which is much more positive.

In light of the disadvantages of the prior art it would be advantageous to have a mechanical lock for a threaded adjuster that is infinitely adjustable and which is not dependent on the integrity of the installation technique.

### SUMMARY OF THE INVENTION

One embodiment of the present invention is directed toward a bearing adjuster lock having a bearing adjuster, a locking device and a combined differential carrier and bearing cap. The locking device can extend through a channel in the bearing cap to the bearing adjuster. The locking device deforms the threads of the bearing adjuster to lock the bearing adjuster with the combined differential carrier and bearing cap.

Another embodiment of the present invention includes providing the channel in the bearing adjuster and locating the locking device through the channel so that it deforms the shared threads of the combined differential carrier and bearing cap to lock the combined differential carrier and bearing cap with the bearing adjuster. The present invention may also be used with an input bearing system.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic, cut-away view of one embodiment of the present invention;

FIG. 2 is a detail of a portion of the structure depicted in FIG. 1;

FIG. 3 is a schematic, cut-away view of another embodiment of the present invention;

FIG. 4 is a detail of a portion of the structure depicted in FIG. 3;

FIG. 5 is a partial, schematic cut-away view of the present invention utilized with an input bearing adjuster and an input bearing system;

FIG. 6 is a partial, schematic view of another embodiment of the invention depicted in FIGS. 1 and 2;

FIG. 7 is a schematic, perspective view of one embodiment of a locking device of the present invention; and

FIG. 8 is a schematic, perspective view of another embodiment of a locking device of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

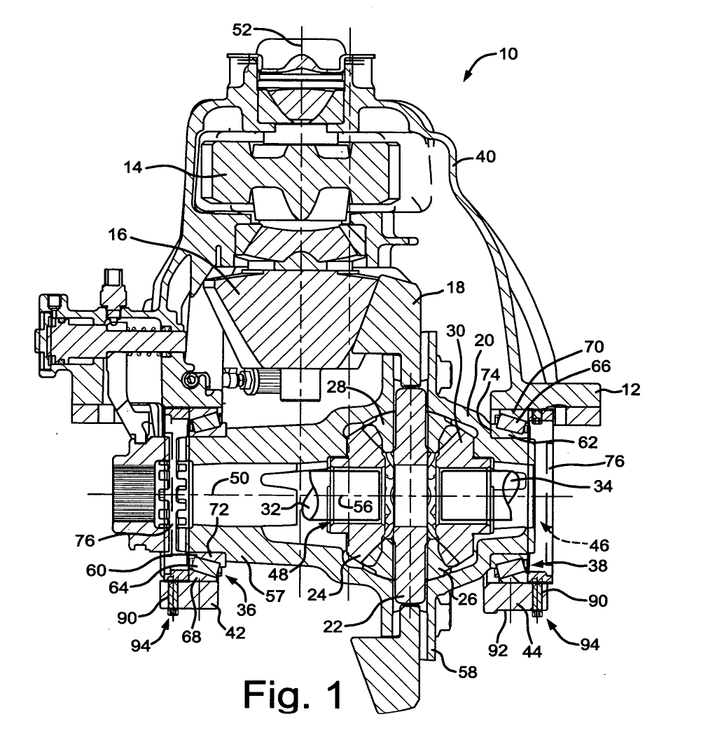

Referring now to the drawings wherein like reference numerals are used to identify identical components in the various views, FIG. 1 illustrates a differential 10 in accordance with the present invention. Differential 10 is provided for use in vehicles to enable a pair of wheels on a common rotational axis to rotate at different speeds. Differential 10 may include a differential carrier 12 that receives a power transmission shaft (not shown), a pinion gear 16, a ring gear 18, a differential case 20, a differential spider 22, a plurality of bevel gears 24, 26, 28, 30, and axle half shafts 32, 34. Differential 10 also includes bearing assemblies 36, 38.

The power transmission shaft may drive a drop gear set 14 and a power divider (not shown), such as used in a forward differential of a tandem axle system. While a forward differential is depicted, it should be appreciated that the present invention can work equally well with a single drive axle system.

Carrier 12 houses, provides supports for, and maintains the relative position of, the other components of differential 10. Carrier 12 may be made from conventional metals and metal alloys such as steel, iron or aluminum and is conventional in the art. Carrier 12 may include several members coupled together using conventional fasteners (not shown). These members may include, but are not limited to, forward member 40 and bearing caps 42, 44. Structures 40, 42, 44 of carrier 12 together define a pair of openings 46, 48 disposed about an axis 50 of rotation for axle half shafts 32, 34 and through which shafts 32, 34 extend.

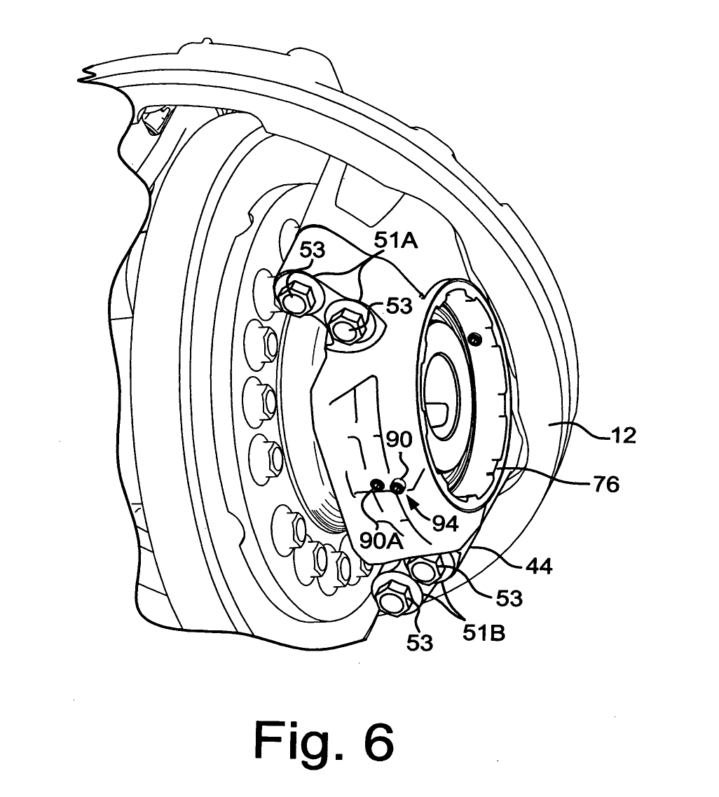

One embodiment of a bearing cap 44 is depicted in FIG. 6. The bearing cap 44 has apertures 51A & 51B for receiving fasteners 53. The fasteners 53 secure the bearing cap 44 to the carrier 12.

Power transmission shaft transfers torque from a drive shaft (not shown) through a power divider (not shown) to pinion gear 16 and is conventional in the art. Pinion gear 16 is disposed about an axis 52 of rotation that extends generally perpendicular to axis 50. Power transmission shaft is supported for rotation within member 40 of carrier 12 by bearing assemblies (not shown).

Pinion gear 16 transfers torque from power transmission shaft to ring gear 18. Pinion gear 16 may be made from conventional metals and metal alloys and may comprise a hypoid gear.

Ring gear 18 is provided to transfer torque from pinion gear 16 to case 20 and is conventional in the art. Ring gear 18 may also be made from conventional metals and metal alloys and may also comprise a hypoid gear. Gear 18 is affixed to case 20 or may be integral therewith and is disposed about axis 56.

Case 20 is provided to house spider 22 and bevel gears 24, 26, 28, 30 and to transfer torque to bevel gears 24, 26, 28, 30. Case 20 is conventional in the art and may be made from conventional metals and metal alloys. Case 20 includes first and second members 57, 58 that are coupled together using fasteners such as bolts or in other ways customary in the art. Case 20 is disposed within carrier 12 and, in particular, within openings 46, 48 of carrier 12. Case 20 is also disposed about axis 50 and is supported for rotation about axis 50 relative to carrier 12 by bearing assemblies 36, 38.

Spider 22 provides a mounting arrangement for bevel gears 26, 28 and is conventional in the art. Spider 22 is coupled to case 20 for rotation therewith and supports at least two bevel gears 26, 28 that rotate with spider 22.

Bevel gears 24, 26, 28, 30 are provided to divide and transfer torque to axle half shafts 32, 34. Gears 24, 26, 28, 30 are conventional in the art and may be made from conventional metals and metal alloys. Gears 26, 28 are mounted on spider 22 for rotation with spider 22. Gears 24, 30 are mounted on axle half shafts 32, 34 for rotation with shafts 32, 34 and rotate in response to rotation of gears 26, 28.

Axle half shafts 32, 34 transfer torque to wheels (not shown) disposed on either side of differential 10. Shafts 32, 34 are conventional in the art and extend outwardly from differential case 20 and carrier 12 through openings 46, 48 Bearing assemblies 36, 38 enable rotation of differential case 20 within carrier 12. Assemblies 36, 38 are disposed within openings 46, 48 of carrier 12 between case 20 and carrier 12 and are disposed about axis 56. Each of the assemblies 36, 38 may include an inner bearing race 60, 62, a bearing 64, 66, and an outer bearing race 68, 70.

The inner bearing races 60, 62 are supported on a radially outer surface of case 20 and abut shoulders 72, 74, respectively, formed in case 20. Bearing 64, 66 are disposed between the inner bearing races 60, 62 and the outer bearing races 68, 70, respectively. Bearings 64, 66 may be any friction reducing devices known to those skilled in the art such as ball bearings, tapered bearings or a combination of tapered and ball bearings. Preferably, bearings 64, 66 are tapered roller bearings. It is also within the scope of the present invention to mount bearings 64, 66 with stationary inner races, as seen in U.S. Pat. No. 4,733,578, which is incorporated by reference in its entirety herein, without departing from the scope of the present invention.

FIG. 1 depicts two bearing adjusters, both identified by reference number 76. For simplicity and clarity, only one bearing adjuster 76 will be described. It must be appreciated, however, that the second bearing adjuster is substantially identical to the bearing adjuster 76 and it functions in a substantially identical manner.

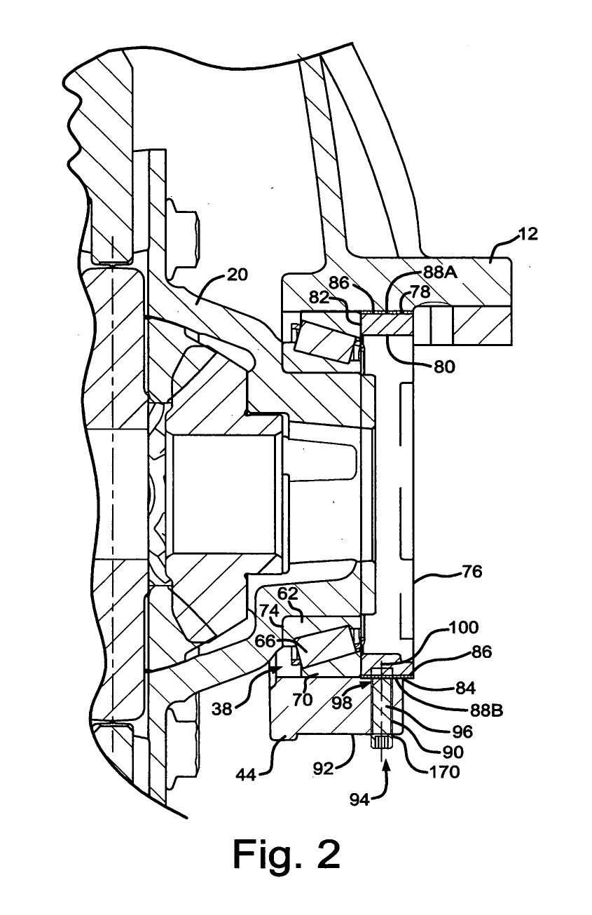

Referring now to FIG. 2, the bearing adjuster 76 has an outer circumferential surface 78, an inner circumferential surface 80 and a race surface 82 bounded by the circumferential surfaces 78, 80. The outer circumferential surface 78 has a set of threads 84 for engaging with a set of threads 86 that is shared by the differential carrier 12 and the bearing cap 44. The set of threads 86 is located on an inner surface 88A of the differential carrier 12 and an inner surface 88B of the bearing cap 44.

The bearing adjuster 76 can be threaded into the threads 84 so that the race surface 82 abuts the outer race 70 of the bearing 66. The preload on the bearing 66 can thus be adjusted by threading the bearing adjuster 76 into or out of the shared threads 86 while the race surface 82 abuts the outer race 70 of the bearing 66. It can be appreciated that the preload on the bearing 66 is infinitely adjustable within the range of the threads 84, 86 of the bearing adjuster 76 and the combined differential carrier 12 and bearing cap 44.

The bearing adjuster 76 may be made of cast, ductile iron, or it may be made of stamped, cast or forged steel.

As seen in both FIGS. 1 and 2, a channel 90 is provided in the bearing cap 44. Preferably, the channel 90 extends from an outer surface 92 of the bearing cap 44 to the inner surface 88B of the bearing cap 44. The channel 90 opens into the inner surface 88B within the shared threads 86.

A locking device 94, comprised of a shaft 96 and a thread deforming structure 98 on the end of the shaft 96, is located within the channel 90. Preferably, the shaft 96 is threaded and the channel 90 is threaded so that the shaft 96 can be selectively advanced within the channel 90.

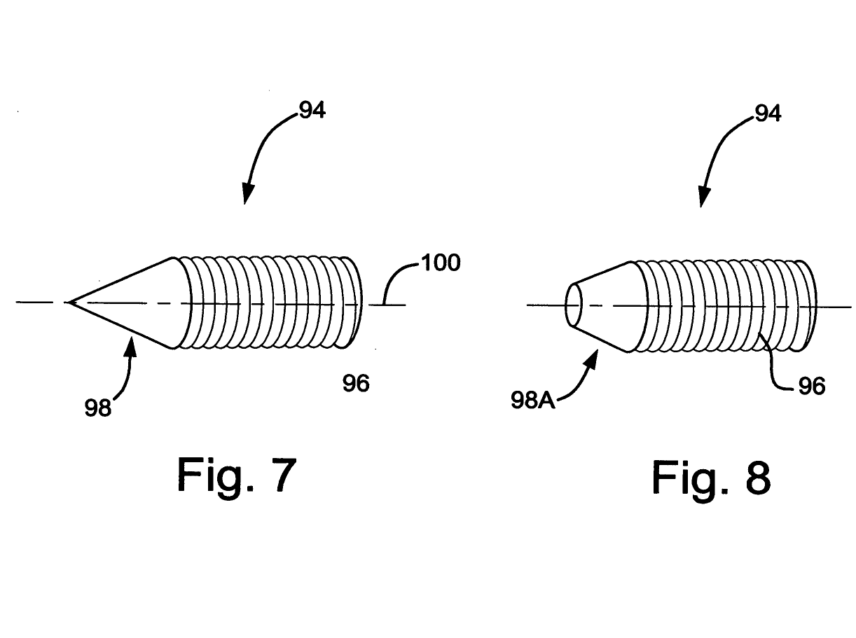

The thread deforming structure 98 may be such as a tapered point, as best seen in FIG. 7. The tapered point may be located along a centerline 100 of the shaft 96. The locking device 94 may also comprise a thread deforming structure 98A that is a frusto-conical shape, as seen in FIG. 8. It can be appreciated that this shape has a larger surface area for contacting the bearing adjuster 76.

Preferably, the shaft 96, or at least the thread deforming structure 98, is made of a material that is harder than the material of the bearing adjuster 76. For example, the shaft 96, or at least the thread deforming structure 98, can be made of heat-treated, hardened carbon steel.

While a single channel 90 is depicted in the bearing cap 44, it must be appreciated that more than one channel 90 can be located in the bearing cap 44. For example, as seen in FIG. 6, a second channel 90A may be located in the bearing cap 44. The second channel 90A may be used to receive the locking device 94 so that it can engage with the bearing adjuster 76 if the bearing adjuster 76 is not aligned with the channel 90, or if it is desired to have more than one lock device 94. The second channel 90A may be located anywhere in the bearing cap 44, and so may the channel 90.

The present invention also comprises locating one or more channels 90, and the locking devices 94, in the differential carrier 12 itself. These channels can be separated from, or in addition to, the channel, or channels, in the bearing cap 44.

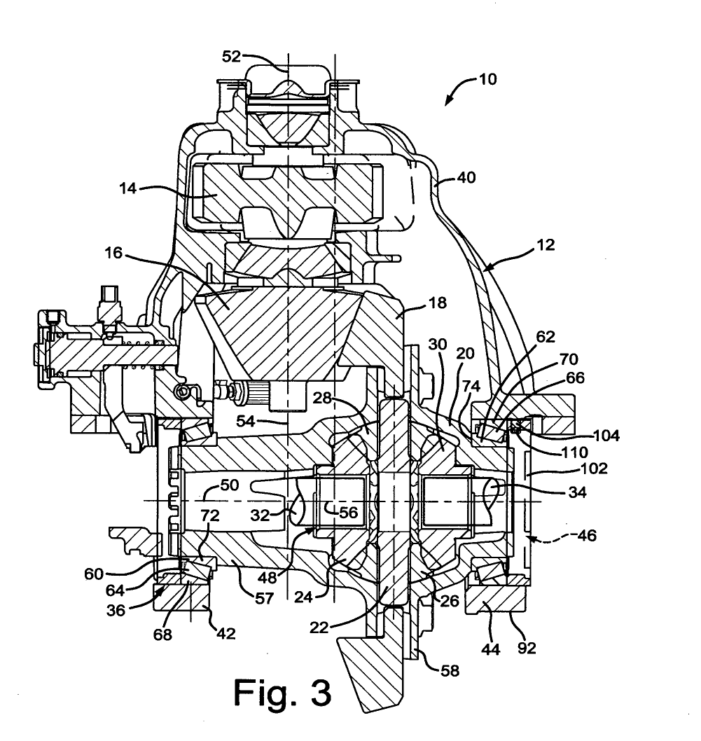

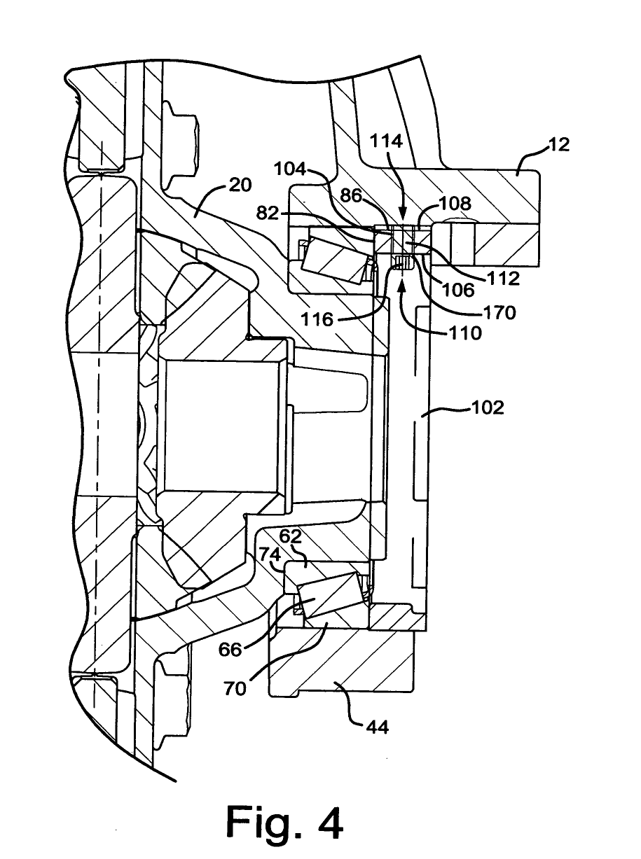

Another embodiment of the present invention is depicted in FIGS. 3 and 4. Reference numbers for like features described above and depicted in FIGS. 1 and 2 will be used in FIGS. 3 and 4. While FIGS. 3 and 4 only depict one bearing adjuster of this alternative embodiment, those skilled in the art will readily appreciate that a second, substantially identical bearing adjuster of this alternative embodiment is located in the differential much as shown in FIG. 1. It is also within the scope of the present invention to use one of the bearing adjusters described above and depicted in FIGS. 1 and 2 with one of the bearing adjusters of the alternative embodiment described below and depicted in FIGS. 3 and 4 in the same differential.

In this embodiment, a bearing adjuster 102 has a channel 104 extending from an inner circumferential surface 106 to an outer circumferential surface 108. Preferably, the channel 104 is threaded for receiving a locking device 110, comprised of a shaft 112 and a thread deforming structure 114 on the end of the shaft 112. The shaft 112 has threads that are complimentary with the threads of the channel 104. The complimentary threads permit the shaft 112 to be selectively advanced within the channel 104 from the inner circumferential surface 106.

The thread deforming structure 114 may be such as a tapered point. The tapered point may be located along a centerline 116 of the shaft 112. The locking device 110 may also comprise a thread deforming structure that is a frusto-conical shape. It can be appreciated that this shape has a larger surface area for contacting the bearing adjuster 102, as compared to the point. Both of these embodiments can be appreciated based on a review of FIGS. 7 and 8.

Preferably, the shaft 112, or at least the thread deforming structure 114, is made of a material that is harder than the material of the differential carrier 12. For example, the shaft 112, or at least the thread deforming structure 114, can be made of heat-treated, hardened carbon steel.

While FIGS. 3 and 4 depict the locking device 110 engaged with the differential carrier 12, it is within the scope of the present invention to orient the channel 104 in the bearing adjuster 102 so that the locking device 110 engages with the bearing cap 44. It is also within the scope of the present invention for more than one channel 104 to be located within the bearing adjuster 102 and for more than one locking device 110 to engage with the differential carrier 12 and/or the bearing cap 44.

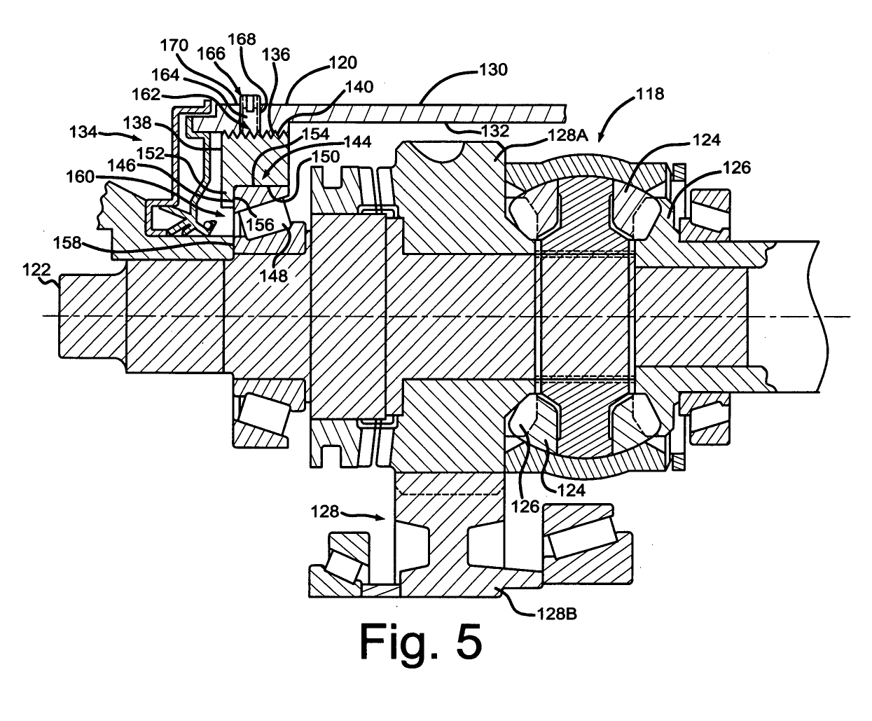

The present invention may also be used with an input bearing system of a vehicle, as described below and depicted in FIG. 5. As seen in FIG. 5, a differential 118 is enclosed by a differential carrier 120. The differential 118 has a shaft 122 and at least two pinion gears 124 attached to the shaft 122. At least two side gears 126 are driven by the pinion gears 124. The pinion gears 124 also mesh with a drop gear set 128. The drop gear set 128, comprised of drive gear 128A and driven gear 128B, drives a pinion shaft and gear (not shown) which in turn drives a ring gear (not shown). The ring gear drives a wheel differential (not shown), as known to those skilled in the art. Other input bearing systems known to those skilled in the art are also within the scope of the present invention.

The carrier 120 has an outer surface 130 and an inner surface 132. The carrier 120 also defines an opening 134. Adjacent the opening 134, the inner surface 132 of the carrier 120 is provided with a set of threads 136. An input bearing adjuster 138, having a complimentary set of threads 140 on an exterior surface 142, engages with the threads 136 of the differential carrier 120.

The input bearing adjuster 138 has a groove 144 for receiving an outer race 146 associated with an input bearing 148. The groove 144 is substantially L-shaped, defining a horizontal portion 150 and a vertical leg 152 connected to the horizontal portion 150. An outer peripheral portion 154 of the outer race 146 abuts the horizontal portion 150 of the groove 144 and a front portion 156 of the outer race 156 is partially contacted by the vertical leg 152.

The input bearing 148, which may be a tapered bearing, is located radially inward from the outer race 146. An inner race 158 is located between the input shaft 122 and the input bearing 148. The input bearing 148, outer race 156 and inner race 158 define an input bearing system 160. It can be appreciated that the input bearing system 160 permits rotation of the input shaft 122 within the differential case 120.

A thread deforming structure 162 is located on an end of a shaft 164 of a locking device 166. The shaft 164 extends through a channel 168 in the differential carrier 120. Preferably, the channel 168 extends substantially perpendicularly through the differential carrier 120 with respect to the inner and outer surfaces 130, 132. In a preferred embodiment, the channel 168 is threaded to receive complimentary threads on the shaft 164. The thread deforming structure 162 may comprise a point on the end of the shaft 164 or it can be a frusto-conical surface, as shown in FIGS. 7 and 8.

It should be appreciated that the input bearing adjuster 138 can be used with differential bearing adjusters 76 and/or 102 and their locking devices without departing from the scope of the present invention.

A preferred method of using the invention depicted in FIGS. 1 and 2 comprises threading the bearing adjuster 76 into the shared threads 86 of the differential carrier 12 and the bearing cap 44. Once the race surface 82 of the bearing adjuster 76 contacts the outer race 70 of the bearing 66, the preload on the bearing 66 can be set by continuing to advance the bearing adjuster 76 into the shared threads 86. It can be appreciated that within the range of the threads 84, 86 the bearing adjuster 76 can be located at an infinite number of positions with respect to the differential carrier 12 and the bearing cap 44.

When the desired amount of preload has been applied to the bearing 66, by virtue of the bearing adjuster 76 being threaded into the differential carrier 12 and bearing cap 44, it is preferred to secure the bearing adjuster 76 so that the preload is constantly maintained. As depicted in the figures, the shaft 96 of the locking device 94 is inserted from the outer surface 92 of the bearing cap 44 into the channel 90. The shaft 96 is inserted until the thread deforming structure 98 contacts the threads 84 on the outer circumferential surface 78 of the bearing adjuster 76. The thread deforming structure 98 is advanced into the threads 84 of the outer circumferential surface 78 to deform the threads 84. The amount of thread deformation is controlled by applying a predetermined amount of torque to the shaft 96. The deformation of the threads 84 by the thread deforming structure 98 locks the bearing adjuster 76 in place in the differential carrier 12 and bearing cap 44. An adhesive 170 can be applied to the shaft 96 where it enters the bearing cap 44 to prevent the shaft 96 from moving.

It is a discovery of the present invention that the threads 84 of the bearing adjuster 76 can be deformed in a variety of different locations as the desired amount of preload is established without diminishing the performance of the threads 84. Additionally, the thread deforming structure 98 and shaft 96 can be repeatedly removed from the channel 90 and reused.

It should be appreciated that the locking device 94 can be located through the differential carrier 12 to contact the bearing adjuster 76 and lock it in place in a similar method.

A preferred method of using the invention depicted in FIGS. 3 and 4 comprises threading the bearing adjuster 102 into the shared threads 86 of the differential carrier 12 and the bearing cap 44. Once the race surface 82 of the bearing adjuster 102 contacts the outer race 70 of the bearing 66, the preload on the bearing 66 can be set by continuing to advance the bearing adjuster 102 into the shared threads 86. It can be appreciated that within the range of the threads 84, 86, the bearing adjuster 102 can be located at an infinite number of positions with respect to the differential carrier 12 and the bearing cap 44

When the desired amount of preload has been applied to the bearing 66 by virtue of the bearing adjuster 102 being threaded into the differential carrier 12 and bearing cap 44, it is preferred to secure the bearing adjuster 102 so that the preload is constantly maintained. The shaft 112 is threaded into the channel 104 from the inner circumferential surface 106. The shaft 112 is inserted until the thread deforming structure 114 contacts the threads 86 on the differential carrier 12. The thread deforming structure 114 is advanced into the threads 86 of the differential carrier 12 to deform the threads 86. The amount of thread deformation is controlled by applying a predetermined amount of torque to the shaft 112. The deformation of the threads 86 by the thread deforming structure 114 locks the bearing adjuster 102 in place in the differential carrier 12. An adhesive 170 can be applied to the shaft 112 where it enters the bearing adjuster 102 to prevent the shaft 112 from moving.

It is a discovery of the present invention that the threads 86 of the differential carrier 12 can be deformed in a variety of different locations as the desired amount of preload is established without diminishing the performance of the threads 86. Additionally, the thread deforming structure 114 and shaft 112 can be repeatedly removed from the channel 104 and reused.

It should be appreciated that the channel 104 can be oriented such that when the locking device 110 is threaded through the channel 104 it engages with the bearing cap 44. This method also locks the bearing adjuster 102 to the differential carrier 12 and the bearing cap 44.

A preferred method of using the invention depicted in FIG. 5 comprises threading the input bearing adjuster 138 into the differential carrier 120. The vertical leg 152 of the adjuster 138 abuts the outer peripheral portion 154 of the outer race 146 to provide a preload to the input bearing 148. Once the desired preload is achieved, it is preferred that the input bearing adjuster 138 be locked in place.

The shaft 164, having the thread deforming structure 162 thereon, is threaded into the channel 168 of the differential carrier 120. The shaft 164 is advanced into the channel 168 until the thread deforming structure 162 deforms the threads 140 of the input bearing adjuster 138. The input bearing adjuster 138 is thus locked in place. An adhesive 170 may be applied to the shaft 164 where it enters channel 168 to secure the shaft 164 in place. While the threads 140 of the input bearing adjuster 138 are deformed by the thread deforming structure 162, it is a discovery of the present invention that the threads 140 are not deformed to the extent that their performance is diminished.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A bearing adjuster lock, comprising:
a differential carrier and a bearing cap for a vehicle, said carrier and said bearing cap sharing a set of internal threads;
a differential case disposed within said differential carrier;
a bearing assembly disposed between both said differential carrier and said bearing cap and said differential case to allow said differential case to rotate within said differential carrier and said bearing cap, said bearing assembly having an inner race in contact with said differential case, an outer race in contact with both said differential carrier and said bearing cap and a bearing disposed between said races; and
a bearing adjuster having a set of external threads for engagement with said shared internal threads of said differential carrier and said bearing cap so that the preload on said bearing is infinitely adjustable within the range of said shared internal threads and said bearing adjuster threads;
a locking device extending from an inner surface of said bearing adjuster through said bearing adjuster to an outer surface of said bearing adjuster, said locking device locking said bearing adjuster to said differential carrier by deforming said set of internal threads.

2. A bearing adjuster lock, comprising:
A combined differential carrier and bearing cap for a vehicle, said carrier and said bearing cap sharing a set of internal threads;
a differential case disposed within said differential carrier;
a bearing assembly disposed between both said differential carrier and said bearing cap and said differential case to allow said differential case to rotate within said differential carrier and said bearing cap, said bearing assembly having an inner race in contact with said differential case, an outer race in contact with said differential carrier and said bearing cap and a bearing disposed between said races; and
a bearing adjuster having a set of external threads for engagement with said shared internal threads of said differential carrier and said bearing cap so that the preload on said bearing is infinitely adjustable within the range of said threads; and
a locking device threaded from an outer surface of said combined differential carrier and bearing cap to said internal threads of said differential carrier, said locking device locking said bearing adjuster to said differential carrier by deforming said external threads of said bearing adjuster.

3. A bearing adjuster lock, comprising:
a bearing adjuster having a channel extending from an inner surface to an outer surface of said bearing adjuster, said outer surface having a set of threads;
a locking device located within said channel, said device having one end with a point; and
a differential carrier and a bearing cap sharing an internal set of threads,
wherein said locking device is located through said channel until it deforms said internal threads of said differential carrier and said bearing cap to lock said bearing adjuster to said differential carrier and said bearing cap.

4. The lock of claim 3, wherein said locking device is threadably engaged with said channel.

5. The lock of claim 3, wherein said threads of said bearing adjuster can be locked with said shared threads of said differential carrier and said bearing cap at any angular relationship.

6. The lock of claim 3, wherein said bearing adjuster abuts an outer race of a differential bearing to adjust the preload on said bearing.

7. The lock of claim 3, wherein said locking device is secured within said channel by an adhesive.

8. A bearing adjuster lock, comprising:
a combined differential carrier and bearing cap having a channel extending from an outer surface to an inner surface of said combined carrier and cap;
a bearing adjuster having an external set of threads for engaging with an internal set of threads shared by said differential carrier and said bearing cap; and
a locking device extending from said outer surface to beyond said shared set of threads of said differential carrier and said bearing cap, said locking device having one end with a point for deforming said external threads of said bearing adjuster to lock said bearing adjuster to said combined differential carrier and bearing cap.

9. The lock of claim 8, wherein said channel is threaded and said locking device has a complimentary set of threads.

10. The lock of claim 8, wherein said channel extends substantially perpendicularly to said inner surface and said outer surface of said differential carrier.

11. The lock of claim 8, wherein said bearing adjuster abuts a differential bearing for adjusting the preload on said bearing.

12. The lock of claim 8, wherein said bearing adjuster is infinitely adjustable within said shared threads of said differential carrier and said bearing cup.

13. The lock of claim 8, wherein said locking device is secured within said channel with an adhesive.

14. The lock of claim 8, wherein said bearing cap has at least two channels for receiving said locking device.

15. A bearing adjuster lock, comprising:
a differential carrier having an outer surface and an inner surface;
an input bearing adjuster having a set of threads for threadably engaging with said inner surface of said differential case; and
a locking device located within a channel extending from said outer surface to said inner surface, said locking device deforming said threads of said input bearing adjuster to lock said input bearing adjuster to said differential carrier.

16. The lock of claim 15, further comprising an input bearing system having an inner race, an outer race and an input bearing.

17. The lock of claim 15, wherein said input bearing adjuster is located entirely within said differential carrier and said input bearing adjuster is a separate component therefrom.

18. The lock of claim 15, wherein said locking device has a thread deforming structure on one end thereof for deforming said threads of said input bearing adjuster.

19. The lock of claim 15, wherein within said threads of said differential carrier and said threads of said input bearing adjuster, said input bearing adjuster may be located at any angular orientation with respect to said differential carrier.

20. The lock of claim 15, wherein said thread deforming structure of said locking device can be engaged with any portion of said threads of said input bearing adjuster to lock said input bearing adjuster to said differential carrier.

21. A bearing adjuster lock, comprising:
a differential carrier having an outer surface and an inner surface;
an input bearing system having an inner race, an outer race and an input bearing;
an input bearing adjuster having a set of threads on an outer surface for engaging with said inner surface of said differential carrier, said input bearing adjuster having an L-shaped groove for receiving said outer race therein; and
a threaded locking device extending substantially perpendicularly through said differential carrier to said threads on said outer surface of said input bearing adjuster;
wherein said locking device deforms said threads of said input adjuster to lock said input bearing adjuster in place at any angular orientation of said input bearing adjuster with respect to said differential carrier to provide a predetermined amount of preload to said bearing.

22. A method of securing an input bearing adjuster to a differential carrier, comprising:
providing a differential carrier having a set of threads on an internal surface of said differential carrier;
providing an input bearing system having an inner race, an outer race and an input bearing;
threadably engaging an outer set of threads on an input bearing adjuster with said threads of said differential carrier and engaging said input bearing adjuster with said outer race of said input bearing system to adjust the preload on said bearing; and
securing said input bearing adjuster to said differential carrier by deforming said threads of said input bearing adjuster with a thread deforming structure on a shaft threaded into said differential carrier.

23. The method of claim 22, wherein the degree of deformation of said threads of said input bearing adjuster is determined by the amount of torque applied to said locking device.

24. A method of securing a differential bearing adjuster to a combined differential carrier and bearing cap, comprising:
threadably engaging a shared set of threads for a combined differential carrier and bearing cap with a set of threads on a differential bearing adjuster until a pre-determined amount of preload is established in a differential bearing; and
locking said differential bearing adjuster to said combined differential carrier and bearing cup by using a locking device inserted from said combined differential carrier and said bearing cup to said differential bearing adjuster to deform said threads of said differential bearing adjuster.

25. The method of claim 24, wherein the degree of deformation of said threads of said input bearing adjuster is determined by the amount of torque applied to said locking device.

26. A method of securing a differential bearing adjuster to a combined differential carrier and bearing cap, comprising:
threadably engaging a shared set of threads for a combined differential carrier and bearing cap with a set of threads on a differential bearing adjuster until a pre-determined amount of preload is established in a differential bearing; and
locking said differential bearing adjuster to said combined differential carrier and bearing cup by using a locking device inserted from said differential bearing adjuster to said combined differential carrier and bearing cup to deform said shared threads of said combined differential carrier and bearing cup.
